(19) United States
(12) Patent Application Publication
(10) Pub. No.: US 2023/0170251 A1
(43) Pub. Date: Jun. 1, 2023

(54) METHOD FOR PRODUCING AN INDIVIDUALISATION ZONE OF AN INTEGRATED CIRCUIT

(71) Applicant: COMMISSARIAT A L'ENERGIE ATOMIQUE ET AUX ENERGIES ALTERNATIVES, Paris (FR)

(72) Inventors: Stefan LANDIS, Grenoble Cedex 09 (FR); Zouhir MEHREZ, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/059,113

(22) Filed: Nov. 28, 2022

(30) Foreign Application Priority Data
Nov. 30, 2021 (FR) 21 12768

(51) Int. Cl. H01L 21/768; H01L 21/02; H01L 21/311

(52) U.S. Cl. CPC H01L 21/76805; H01L 21/76816; H01L 21/76877; H01L 21/02211; H01L 21/31116

(57) ABSTRACT

A method for producing an individualisation zone of a chip including a first and a second level of electric tracks, and an interconnecting level including vias, the method including the following steps: providing the first level and a dielectric layer with the basis of a dielectric material including a non-zero nitrogen concentration, forming a mask on the dielectric layer, etching the dielectric layer through mask openings by a vapour HF etching, so as to form: openings leading to the first level of electric tracks, nitrogenous residues randomly distributed at the level of certain openings, the openings thus including openings with nitrogenous residues and openings without residues, filling the openings so as to form the vias of the interconnecting level, the vias including functional vias at the level of openings without residues and inactive vias at the level of the openings with residues.

### TECHNICAL FIELD

The present invention relates to the individualisation of integrated circuits. It has a particularly advantageous application in the protection of integrated circuits, components or devices integrating such circuits.

### STATE OF THE ART

The individualisation of an integrated circuit in a component enables the unique identification of this component. This, for example, makes it possible to protect the component against attacks by emulating functions that the component is meant to do.

In order to uniquely identify an integrated circuit, there are solutions aiming to use functional dispersions inherent to integrated circuits. The resistances of the metal interconnecting lines or vias different from one circuit to the other, which induces falls in voltage along the path used by the electric signal. The response time of the signals therefore differs due to the variability induced over the propagation time of the signals at the limits of the electronic constraints of the circuit, or also due to the instability at the start-up of the components, like for example SRAMS (Static Random Access Memory) memories which have a unique state upon each start-up.

However, these solutions are very sensitive to environmental variations or to ageing. In particular, changes in temperatures, supply voltages or electromagnetic interferences can affect the performances of these solutions by decreasing their robustness. Thus, the response times of an integrated circuit can evolve over time. This results in that a legitimate circuit can optionally be declared as being counterfeit.

There is therefore a need consisting of limiting, even resolving, the problems of known solutions.

### SUMMARY

To achieve this aim, according to an embodiment, a method for achieving a zone for individualising a microelectronic chip is provided, said chip comprising at least:
one first and one second electric track levels,
one interconnecting level located between the first and second electric track levels and comprising vias intended to electrically connect the electric tracks of the first level with electric tracks of the second level,
the chip having at least one other zone, distinct from the individualisation zone, intended to form a functional zone of the chip.

The method comprises at least the following steps carried out at the level of the chip individualisation zone:
providing at least the first electric track levels,
forming at least one dielectric layer on the first level, said dielectric layer comprising a non-zero nitrogen concentration,
forming on the at least one dielectric layer, an etching mask having mask openings located at least partially to the right of the electric tracks and making the at least one dielectric layer accessible,
etching the at least one dielectric layer through mask openings by at least one vapour phase hydrofluoric (HF) acid-based etching, so as to form:
   openings leading to the first electric track level,
   nitrogenous residues randomly distributed at the level of certain openings, the openings thus comprising openings with nitrogenous residues and residue-free openings,
filling the openings with an electrically conductive material so as to form at least the vias of the interconnecting level, said vias comprising functional vias at the level of the residue-free openings and inactive vias at the level of the openings with nitrogenous residues.

The method further comprises, prior to the formation of nitrogenous residues in the individualisation zone, a formation of a protective mask on the zone intended to form the functional zone of the chip.

Thus, the nitrogenous residues prevent the electrically conductive material being correctly deposited in certain openings, in particular by affecting the conformity of the deposition. These nitrogenous residues thus lead to the formation of defects in certain vias.

The method proposed therefore makes it possible to voluntarily, but randomly degrade the interconnecting level. This voluntary degradation makes it possible to create inactive vias distributed randomly within the chip individualisation zone. The response diagram of the chip or of the integrated circuit will therefore be closely linked to this random character. This response will consequently be unique. Each integrated circuit achieved by this method thus generates a different response. Moreover, the response diagram of the integrated circuit will be stable over time, contrary to the solutions described above in the section relating to the state of the art.

The individualisation zone is difficult, even unable, to physically clone. It can be qualified by PUF(Physically Unclonable Function). It is therefore possible to make the integrated circuit comprising this individualisation zone unique.

The method according to the invention thus proposes a reliable solution, that can be easily implemented and at a reduced cost, in order to achieve an individualisation zone of an integrated circuit. This thus makes it possible to individualise circuits without resorting to specific lithography technologies to modify, from one chip to another, the patterns of the individualisation zone.

The nitrogenous residues are formed during vapour HF etching, because the dielectric layer comprises a non-zero nitrogen concentration. Such nitrogenous residues cannot be formed if said dielectric layer does not comprise any nitrogen. Typically, an SiO2-based dielectric layer formed by chemical vapour deposition (CVD) using a nitrogenous gas, has a non-zero nitrogen concentration. An SiO2-based dielectric layer formed by thermal oxidation of silicon does not comprise any nitrogen and cannot be directly implemented in this method. Other steps aiming to introduce nitrogen into such a layer, for example by implantation or by thermal annealing under nitrogen flow, should thus be done prior to the vapour HF etching.

Another aspect relates to a method for producing a microelectronic device comprising at least one integrated circuit, the integrated circuit comprising at least:
one first and one second electric track levels,
one interconnecting level located between the first and second electric track levels and comprising vias intended to electrically connect the tracks of the first level with the tracks of the second level,
one individualisation zone of the integrated circuit.

The individualisation zone is achieved by implementing the method described above, preferably only on one part of the integrated circuit.

By microelectronic device, this means any type of device produced with microelectronic means. These devices in particular comprise, in addition to devices with a purely electronic purpose, micromechanical or electromechanical (MEMS, NEMS, etc.) devices, as well as optical or optoelectronic (MOEMS, etc.) devices. This can be a device intended to ensure an electronic, optical, mechanical, etc. function. It can also be an intermediate product, only intended for the production of another microelectronic device.

### BRIEF DESCRIPTION OF THE FIGURES

The aims, objectives, as well as the features and advantages of the invention will best emerge from the detailed description of an embodiment of the latter, which is illustrated by the following accompanying drawings, wherein:

FIGS. 1A, 2A, 3A, 4A, 5A, 6A, 7A, 8A, 9A, 10A, 11A, 12A, 13A schematically illustrate, as a cross-section, steps of an embodiment of an individualisation zone of an integrated circuit according to the present invention.

FIGS. 1B, 2B, 3B, 4B, 5B, 6B, 7B, 8B, 9B, 10B, 11B, 12B, 13B schematically illustrate, as a top view, the steps illustrated in the corresponding FIGS. 1A, 2A, 3A, 4A, 5A, 6A, 7A, 8A, 9A, 10A, 11A, 12A, 13A.

FIG. 6C is a scanning electron microscope image illustrating the formation of nitrogenous residues, according to an embodiment of the present invention.

The drawings are given as examples and are not limiting of the invention. They constitute principle schematic representations intended to facilitate the understanding of the invention and are not necessarily to the scale of practical applications. In particular, on the principle diagrams, the thicknesses of the different layers, vias, patterns and raised parts are not representative of reality.

### DETAILED DESCRIPTION

Before starting a detailed review of embodiments of the invention, below are stated optional features which can optionally be used in association or alternatively:

According to an example, the formation of the at least one dielectric layer with the basis of a dielectric material comprising a non-zero nitrogen concentration is done by chemical vapour deposition from a gaseous precursor comprising silicon and a nitrogenous compound source.

According to an example, the gaseous precursor is taken from among silane (SiH4), tetraethoxysilane (TEOS), tetramethoxysilane (TMOS).

According to an example, the nitrogenous compound source is an N2O or N2 gas, for example a vector gas.

According to an example, the at least one dielectric layer is SiOxNy- or SixNy- or SiOxCyNz-based with x, y, z of non-zero positive rational numbers.

According to an example, the method further comprises, after formation of the at least one dielectric layer, a thermal annealing performed under nitrogen flow (N2). This makes it possible to increase the nitrogen concentration in the at least one dielectric layer.

According to an example, the nitrogen atomic concentration of the dielectric material of the at least one dielectric layer is greater than 1% at.

According to an example, the etching mask is formed with the basis of a material A, such that the etching has an etching selectivity Sdielec: A between the dielectric material and the material A, greater than or equal to 10:1.

According to an example, the material A is chosen from among TiN, SiN, Si.

According to an example, the formation of the at least one dielectric layer is configured such that the nitrogen concentration is inhomogeneous within the at least one dielectric layer. This makes it possible to obtain a random distribution of nitrogenous residues according to a particular profile, making it more difficult still to reproduce such an individualisation zone.

According to an example, the chip is inclined vis-à-vis the nitrogenous compound source during the formation of the at least one dielectric layer.

The production of random inactive vias is done only in the at least one individualisation zone. The integrated circuit has at least one other zone, distinct from the individualisation zone, preferably intended to form a functional zone for the integrated circuit. This other zone typically has a larger surface than the surface of the individualisation zone. In particular, the functional zone can have a surface at least twice greater than that of the individualisation zone. The first and the second electric track levels, as well as the interconnecting level extend into said at least one other zone. The functional zone is intended to ensure logical functions for the expected functioning of the integrated circuit. The electric tracks and the vias of this functional zone are typically faultless. Further to the electric tracks, this functional zone can comprise microelectronic structures, such as for example, transistors, diodes, MEMS, etc. The functional zone is achieved in a standard manner, with methods well-known to a person skilled in the art. Below, only the individualisation zone and its production method are illustrated and detailed.

In the scope of the present invention, a so-called PUF individualisation zone is fully differentiated from such a functional zone, for example intended to perform logical operations. The individualisation zone has itself mainly and preferably only as a function of enabling the unique identification of the chip and therefore the authentication of the chip. To this end, and as will be detailed below, during the production method, it is provided to randomly degrade the interconnecting level and/or the second electric track level so as to obtain inactive vias. More specifically, it is provided to randomly create defects at the level certain vias and/or certain tracks of the second level, so as to make these vias or these tracks inactive.

A response diagram of the integrated circuit is obtained by applying an electric or logical test routine at the inputs (tracks of the first level, for example) of the individualisation zone, then by measuring the electric or logical state at the output (tracks of the second level for this same example) of the individualisation zone. The principle is that an individualisation zone is disposed for each integrated circuit, comprising a unique network of functional vias and inactive vias. The response of each integrated circuit will therefore be different. Each integrated circuit can therefore be identified uniquely. The individualisation zone can be qualified as a PUF zone and the functional zone can be qualified as a non-PUF zone.

According to the invention, the response diagram of the integrated circuit depends on the number and on the position of the inactive vias in the individualisation zone.

The individualisation zone is accessible distinctly from the functional zone. The individualisation zone is localised on a zone delimited from the chip. The individualisation zone is, for example, polygonal-shaped, for example rectangular. Thus, any faulty zone cannot be assimilable to a PUF individualisation zone. Likewise, any non-faulty zone cannot be assimilable to a functional zone.

An interconnecting level comprises conductive portions generally qualified as vias, which are intended to connect tracks of a first level with tracks of a second level. The different electric track and interconnecting levels are further generally insulated from the other elements of the integrated circuit by at least one dielectric layer. It will be noted that vias can connect tracks of two levels which are not directly successive, but which are themselves separated by one or more other levels.

The method is typically implemented in the so-called “Back End Of Line” (BEOL) production steps, corresponding to the production of electric interconnecting levels.

In the present application, the terms “chip” and “integrated circuit” are used synonymously.

It is specified that, in the scope of the present invention, the term “via” groups together all the electric connections such as terminals, lines and conductive structures which extend, preferably perpendicularly, between two layers, successive or not, of the integrated circuit, that is between two electric track levels. Each electric track level extends mainly along a plane and can comprise functional micromechanical structures, such as transistors, for example. Preferably, the vias each form a terminal of substantially circular cross-section.

It is specified that, in the scope of the present invention, the terms “on”, “surmounts”, “covers”, “underlying”, “opposite” and their equivalents do not necessarily mean “in contact with”. Thus, for example, the deposition, the extension, the gluing, the assembly or the application of a first layer on a second layer, does not necessarily mean that the two layers are directly in contact with one another, but means that the first layer covers at least partially the second layer by being either directly in contact with it, or by being separated from it by at least one other layer or at least one other element.

A layer can moreover be composed of several sublayers of one same material or of different materials.

By a substrate, a film, a layer, “with the basis” of a material A, this means a substrate, a film, a layer comprising this material A only or this material A and optionally other materials, for example doping elements.

Several embodiments of the invention implementing successive steps of the production method are described below. Unless explicitly mentioned otherwise, the adjective “successive” does not necessarily imply, even if this is generally preferred, that the steps follow one another immediately, intermediate steps could separate them.

Moreover, the term “step” means the performance of a part of the method, and can mean a set of substeps.

Moreover, the term “step” does not compulsorily mean that the actions performed during a step are simultaneous or immediately successive. Certain actions of a first step can in particular be followed by actions linked to a different step, and other actions of the first step can then be resumed. Thus, the term “step” does not necessarily mean single and inseparable actions over time and in the sequence of phases of the method.

The word “dielectric” qualifies a material of which the electric conductivity is sufficiently low in the given application to serve as an insulator. In the present invention, a dielectric material preferably has a dielectric constant of less than 7.

By “selective etching vis-à-vis” or “etching having a selectivity vis-à-vis”, this means an etching configured to remove a material A or a layer A vis-à-vis a material B or a layer B, and having an etching speed of the material A greater than the etching speed of the material B. The selectivity is the ratio between the etching speed of the material A and the etching speed of the material B.

In the scope of the present invention, an organic material or organo-mineral material which could be shaped by an exposure to an electron, photon or X-ray beam or mechanically, is qualified as a resin.

As an example, resins conventionally used in microelectronics, polystyrene (PS)—, methacrylate-(for example, polymethyl methacrylate PMMA), hydrosilsesquioxane (HSQ)-, polyhydroxystyrene (PHS)-based resins, etc. can be mentioned. The interest of using a resin is that it is easy to deposit a significant thickness of several hundred nanometres to several microns.

A preferably orthonormal marker, comprising the axes x, y, z is represented in the accompanying figures. When one single marker is represented on one same set of figures, this marker is applied to all the figures of this set.

In the present patent application, preferably thickness will be referred to for a layer and depth for an etching. The thickness is taken along a direction normal to the main extension plane of the layer, and the depth is taken perpendicularly to the basal plane xy of the substrate. Thus, a layer typically has a thickness along z, and an etching has a depth along z also. The relative terms “on”, “surmounts”, “under”, “underlying” refer to positions taken along the direction z.

An element located “in vertical alignment with” or “to the right of” another element means that these two elements are both located on one same line perpendicular to a plane wherein mainly extends a lower or upper face of a substrate, i.e. on one same line oriented vertically in the figures.

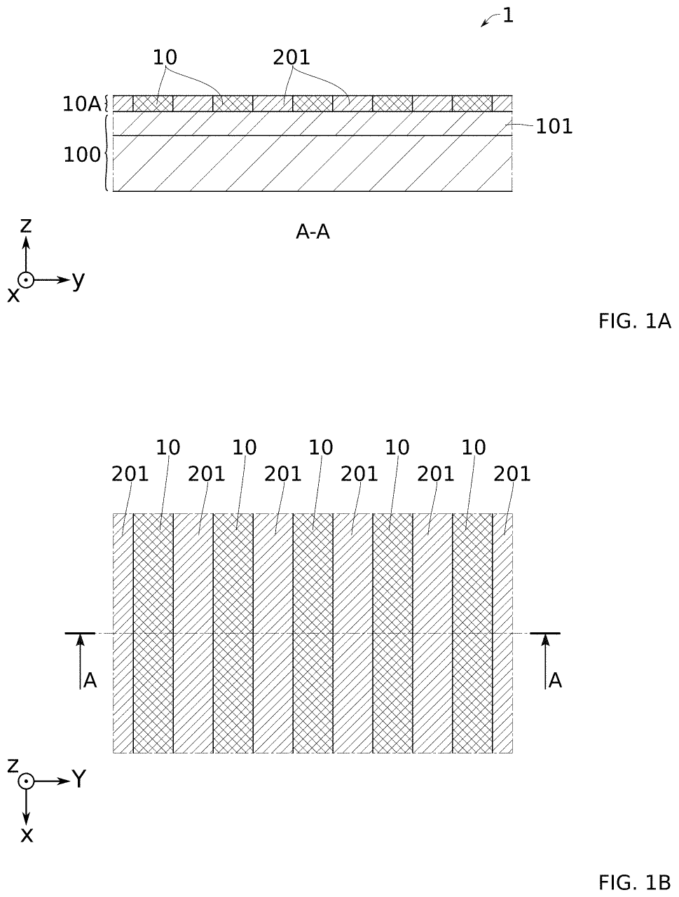

FIGS. 1A and 1B schematically illustrate the formation of a first level 10A of electric tracks 10 on a substrate 100, in the individualisation zone 1. The substrate 100 can typically be silicon-based and comprise elementary components, for example transistors, on a so-called FEOL (Front End Of Line) level 101.

The level 10A extends mainly along a plane xy. The first level of tracks 10A comprises electric tracks 10. These electric tracks 10 are formed of a conductive material such as copper; these electric tracks 10 are typically separated and/or encapsulated by a dielectric layer 201. This dielectric layer also has the function of forming a barrier against the diffusion of the copper. This dielectric layer 201 is, for example, formed of SiO2.

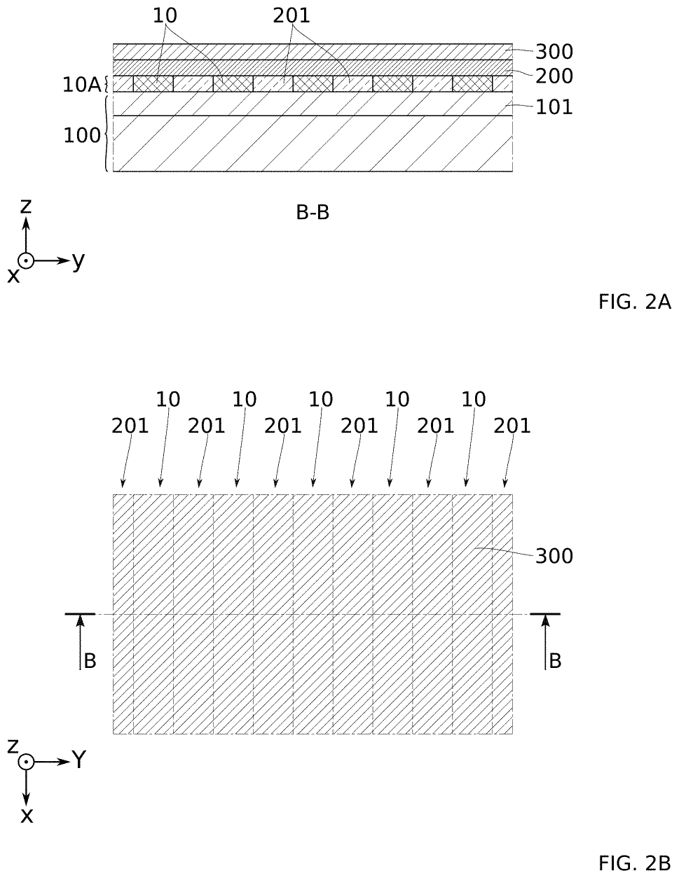

FIGS. 2A and 2B illustrate the formation of a dielectric layer 200 and of an etching mask 300 stacked along z on the first level of tracks 10A, towards the formation of the interconnecting level 30A.

The dielectric layer 200 is preferably directly in contact with the first level 10A. It is with the basis of a dielectric material comprising nitrogen. It can be SiOxNy- or SixNy- or SiOxCyNz-based with x, y, z of non-zero positive rational numbers.

This dielectric layer 200 can be deposited by chemical vapour deposition (CVD), for example by plasma enhanced chemical vapour deposition (PECVD), or by low pressure chemical vapour deposition (LPCVD). A gaseous precursor of silane (SiH4), or tetraethoxysilane (TEOS), or tetramethoxysilane (TMOS) type is preferably used. The deposition is done preferably in the presence of a nitrogenous gas of the N2O or N2 type. The concentration of nitrogen compounds in the gaseous mixture used (precursor/nitrogenous gas) can be between 10% and 90%. This makes it possible to obtain nitrogen concentrations in the dielectric layer 200 of around a few % at to a few tens of % at, for example between 1% at and 50% at. This makes it possible to adjust the concentration of nitrogenous residues subsequently obtained from said dielectric layer 200.

An SiO2-based dielectric layer 200 formed from a TEOS or TMOS precursor under N2O typically has a nitrogen concentration less than an SiO2-based dielectric layer 200 formed from a silane precursor under N2O. The nitrogen concentration in a dielectric layer 200 of “TEOS” type generally reaches a few % at, for example 1 to 4% at. The nitrogen concentration in a “silane”-type dielectric layer 200 can reach several tens of % at, for example 10 to 50% at. The nitrogenous residues formed from a “TEOS” dielectric layer 200 will therefore be less numerous and/or less dense than the nitrogenous residues formed from a “silane” dielectric layer 200. For example, a “TEOS” dielectric layer 200 can advantageously be chosen for back end levels having a low density of electric tracks, for example less than 10-2 μm-2. For example, a “silane” dielectric layer 200 can be chosen for back end levels having a greater density of electric tracks, for example greater than or equal to 10-2 μm-2.

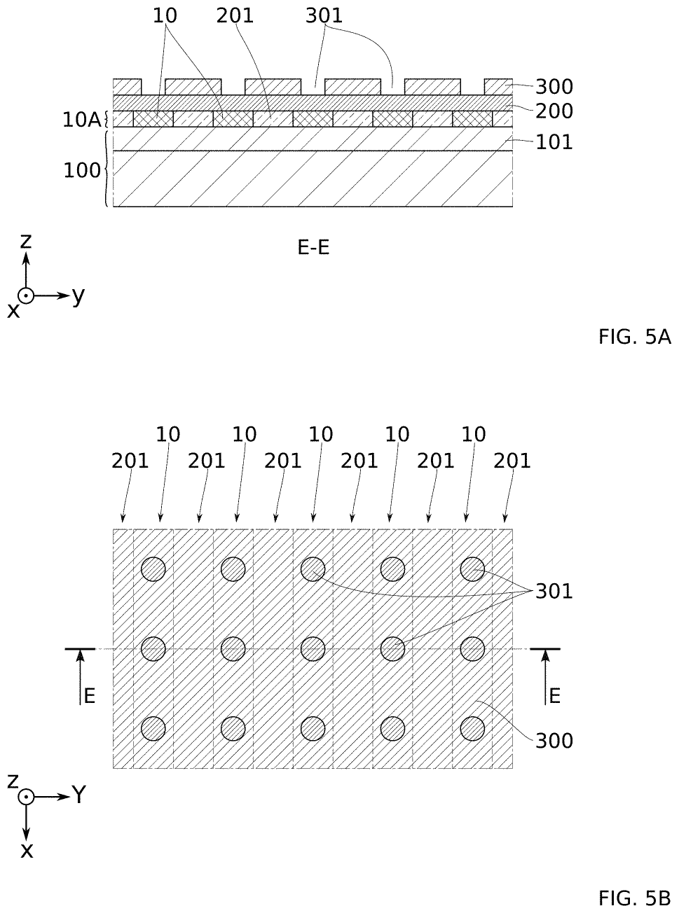

The reader can, in particular, refer to the document, “Effects of process parameters on the properties of silicon oxide films using plasma enhanced chemical vapor deposition with tetramethoxysilane, T. H. Chung, M. S. Kang, C. J. Chung, Y. Kim, Current Applied Physics 9 (2009) 598-604”, FIG. 5B, to estimate the nitrogen atomic concentration (a few % at) present in an SiO2-based dielectric layer 200 formed from TMOS and N2O, according to the ratio of the partial TMOS and N2O pressures in the CVD reactor.

The reader can, in particular, refer to the document, “Comparative study between silicon-rich oxide films obtained by LPCVD and PECVD, A. Moralesa, J. Barretoa, C. Domíngueza, M. Rieraa, M. Acevesb, J. Carrilloc, Physica E 38 (2007) 54-58″, table 1, to estimate the nitrogen atomic concentration present in an SiO2-based dielectric layer 200 formed by PECVD from silane and N2O. This can reach ten % at.

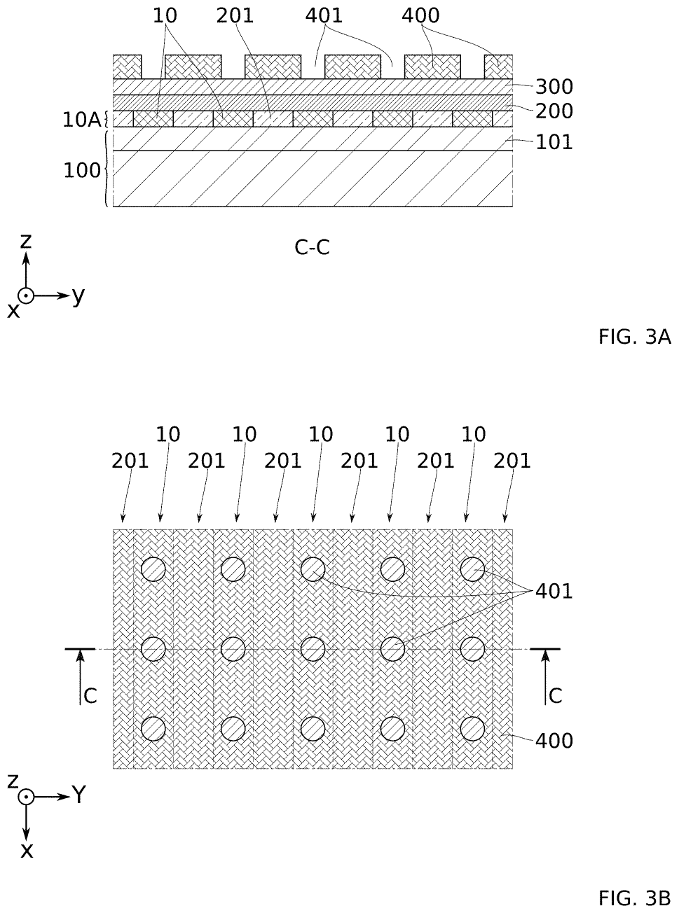

The reader can, in particular, refer to the document, “Study of nitrogen-rich silicon oxynitride films obtained by PECVD, D. Criadol. Pereyra M. I. Alayo, Materials Characterization 50 (2003) 167-171”, FIG. 3, to estimate the nitrogen atomic concentration present in an SiO2-based dielectric layer 200 formed by PECVD from silane and an N2;N2O mixture. This can reach several tens of % at.

According to a possibility, the dielectric layer 200 is silicon nitride-based, for example SiN or Si3N4.

The dielectric layer 200 can have a thickness typically of between 50 nm and 500 nm, for example of around 100 nm.

Optionally, after formation of the dielectric layer 200, one or more thermal annealing actions under nitrogen flow are carried out. This makes it possible to further increase the nitrogen concentration in the dielectric layer 200.

Moreover, it is possible to adjust the deposition conditions, so as to make the deposition non-homogenous on one same wafer comprising different microelectronic chips or between different wafers comprising different microelectronic chips. This inhomogeneity can be obtained by controlling the inclination of the wafer in the deposition chamber vis-à-vis gas injection nozzles, or for example by modifying the respective distance of the injection nozzles with respect to the wafer. A variation in nitrogen concentration of a few % to 20% can thus be obtained between different zones of one same wafer during the deposition of the dielectric layer 200. An additional variable can thus be introduced in the random distribution of nitrogenous residues between different chips. This makes it possible to reinforce the random and unclonable character of the individualisation zones formed by the method.

The etching mask 300 is formed on the dielectric layer 200. It is preferably chosen made of a material A having a significant etching selectivity vis-à-vis the dielectric material, for a vapour HF etching. The etching selectivity S dielec: A between the dielectric material and the material A is preferably greater than or equal to 10:1. For an SiO2-based dielectric layer 200, the etching mask 300 can be SiN- or TiN-based. For an SiN-based dielectric layer 200, the etching mask 300 can be Si-based.

As illustrated in FIGS. 3A, 3B, a resin-based mask 400 comprising openings 401 forming via patterns is deposited on the etching mask 300. These openings 401 of the mask 400 in particular serve to open the etching mask 300. The openings 401 are located at least partially to the right of the electric tracks 10. The openings 401 have a lateral dimension, typically a diameter, of between 70 nm and 1000 nm.

According to the technique implemented to open the mask 300, the mask 400 can be formed of one or more layers. It can be photosensitive resin-based, for example with positive tonality. An underlying BARC (Bottom Anti-Reflective Coating)-type anti-reflective coating is preferably interleaved between the mask 300 and the mask 400. The mask 400 made of photosensitive resin can have a thickness of between 50 nm and 300 nm. This thickness can be adjusted, for example according to the track level considered in the stack and consequently the resolution of the vias. The anti-reflective coating can have a thickness of between 25 nm and 35 nm, for example around 30 nm.

Alternatively, the mask 400 can comprise two SOC (spin on carbon) and SiARC (silicon anti-reflective coating)-type layers, as well as a photosensitive resin layer (mask called “Tri Layer”). The thicknesses of these three layers vary according to the nature of the layers and according to the dimensions of the targeted vias. They are typically around 150 nm for the SOC, 30 nm for the SiARC and around 100 nm for the resin.

The different layers of this mask 400 can be deposited by a conventional spin coating method.

The openings 401 of the mask 400 are produced by implementing conventional lithography techniques, such as optical lithography, e-beam electronic lithography, nanoprinting lithography or any other lithography technique known to a person skilled in the art.

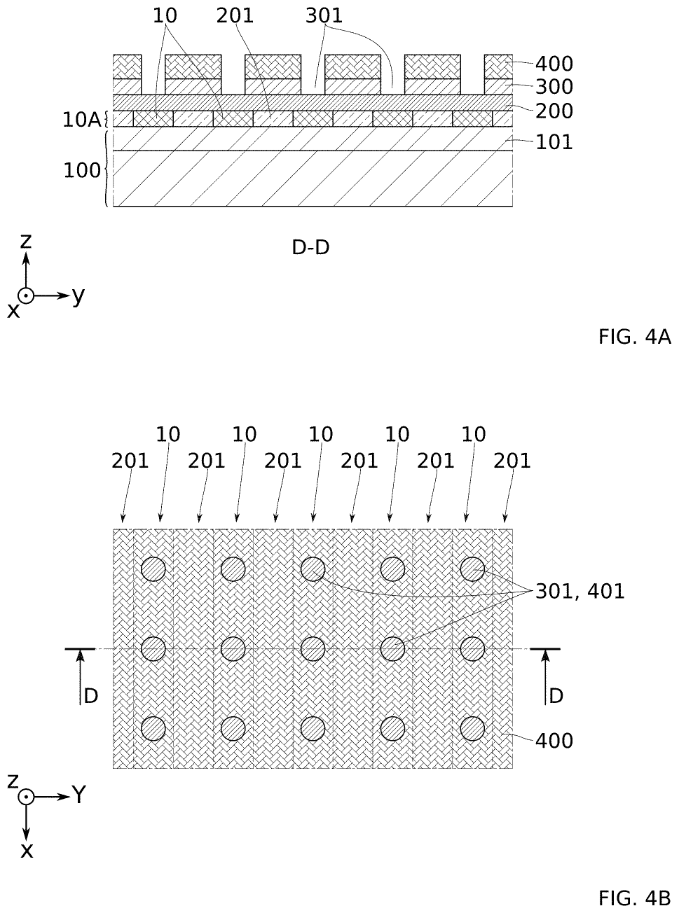

As illustrated in FIGS. 4A, 4B, an etching is carried out in the etching mask 300 to transfer the patterns 401 of the mask 400 there. This etching is configured to form the mask openings 301.

The anti-reflective coating and the etching mask 300 can be plasma etched, using a chlorine-based etching chemistry, for example Cl2/BCl3. This type of plasma makes it possible to use a resin-based mask 400 having a thin thickness, for example less than 200 nm.

As illustrated in FIGS. 5A, 5B, the mask 400 is preferably removed after opening the etching mask 300. This removal can be done conventionally by a so-called “stripping” step, for example by oxygen-based plasma.

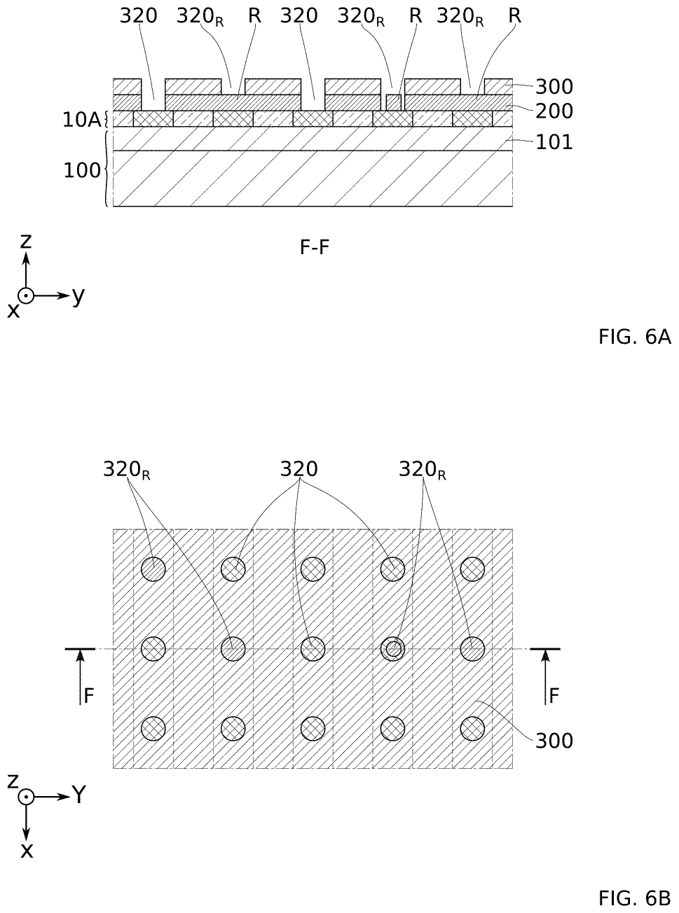

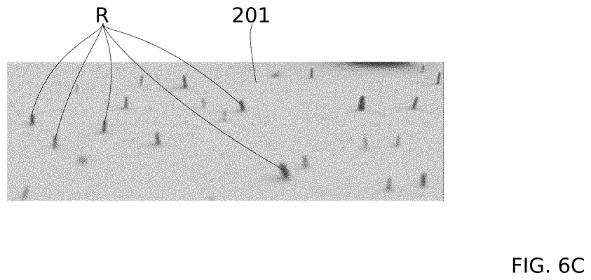

As illustrated in FIGS. 6A, 6B, the dielectric layer 200 is then etched through the openings 301 of the etching mask 300. This etching is typically performed by vapour HF. The dielectric material of the dielectric layer 200 is thus etched by leaving residues R in certain openings 320R of the dielectric layer 200. These residues R are nitrogenous residues contained in the dielectric layer 200, and formed during vapour HF etching. The residues R are typically ammonium fluorosilicate-based.

For a silicon oxide-based dielectric layer 200, the chemical reaction during the HF etching is potentially the following:

SiO2(s)+4HF(g)+2NH4F(s)→(NH4)2SiF6(s)+SiF4(g)+2H2O(g).

For a silicon nitride-based dielectric layer 200, the chemical reaction during the HF etching is potentially the following:

Si3N4(s)+16HF(g)→2(NH4)2SiF6(s)+SiF4(g).

After etching, openings 320 without residues and openings 320R with residues R are thus obtained. The openings 320R with residues R can be totally or partially filled with residues R. The distribution of residues R is totally random.

FIG. 6C illustrates an image acquired by a scanning electron microscope (SEM) of a “silane”-type silicon oxide layer, etched by vapour HF according to an example of implementation of the method. The residues are presented in the form of residual pillars. The diameter of the residual pillars is, in this case, between 300 nm and 1.2 μm.

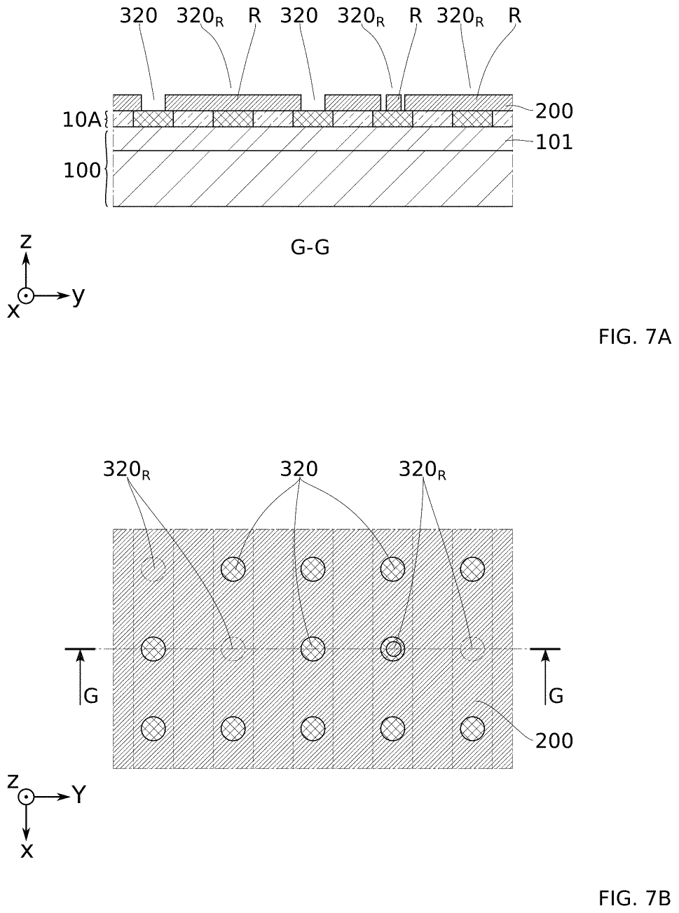

As illustrated in FIGS. 7A, 7B, optionally, after etching of the dielectric layer 200 at the level of the mask openings 301, the etching mask 300 can be advantageously remoted selectively with respect to the dielectric layer 200 and to the residues R.

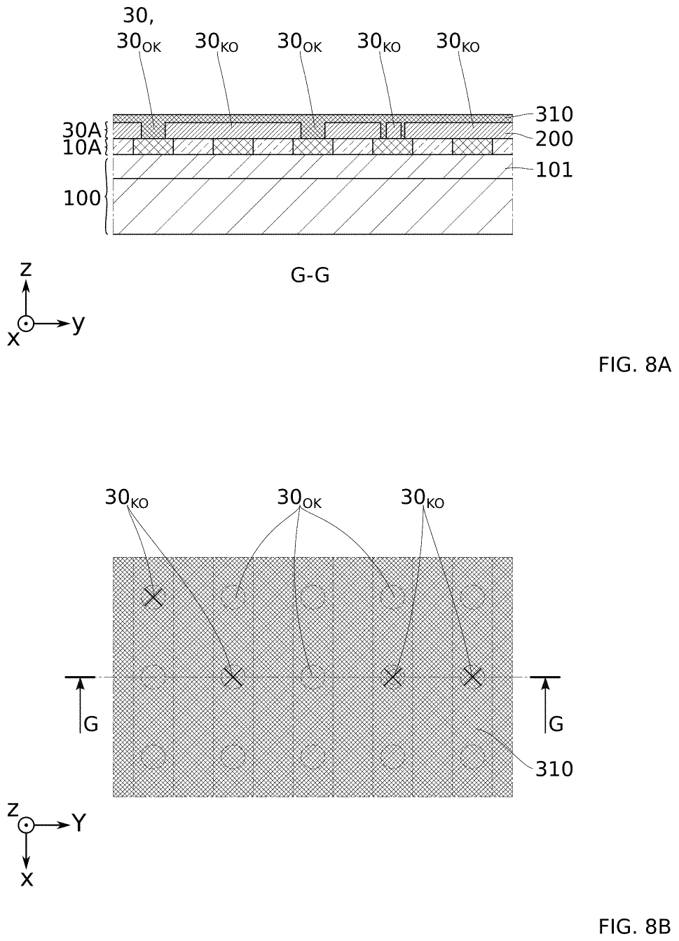

As illustrated in FIGS. 8A, 8B, the openings 320, 320R are then filled by a conductive material 310, so as to respectively form functional vias 300K and inactive vias 30KO. The functional vias 300K and the inactive vias 30KO form the interconnecting level 30A. The conductive material is preferably copper. The copper deposition methods, for example, an electrochemical deposition (ECD), are well-known to a person skilled in the art.

The functional vias 300K typically have a nominal conductivity during a dedicated electric test. The inactive vias 30KO typically have a conductivity less than the nominal conductivity, even a zero conductivity, during this electric test. A certain number of vias 30KO, randomly distributed, will therefore not be connected or will be incorrectly connected to the lines 10.

According to a possibility, the incorrectly connected vias 30KO can be subsequently deactivated, for example if the stability of their electric connection is not efficient enough. They can be used as is, by taking advantage of their high connection resistance (the metal contact surface being weaker than for a functional via 300K). This high connection resistance in particular induces a response time different from the circuitry, for example during the electric test of the individualisation zone.

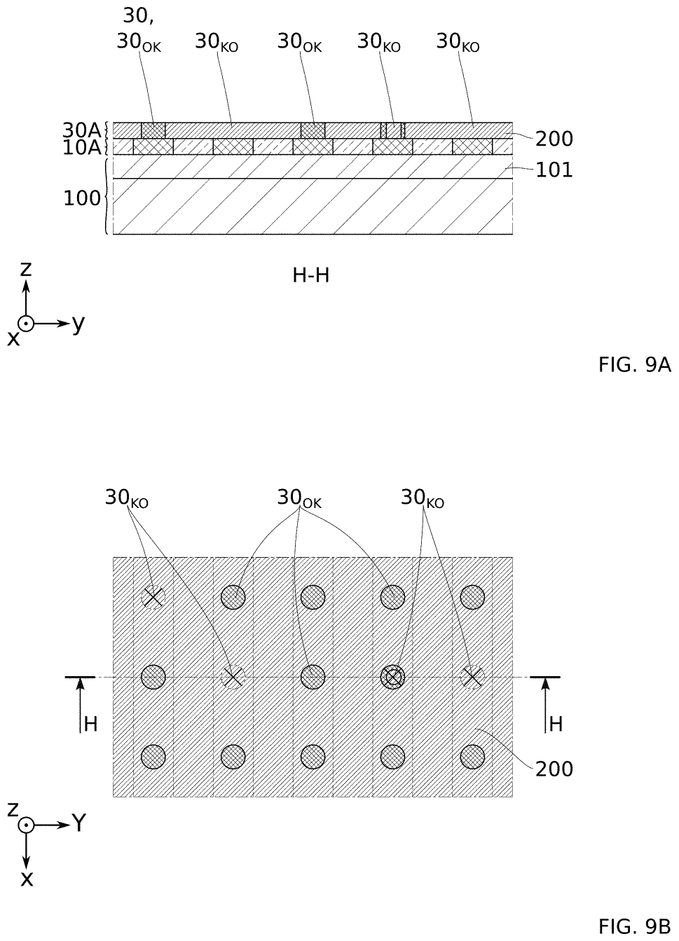

As illustrated in FIGS. 9A, 9B, the excess copper deposited can be removed, for example by chemical-mechanical polishing (CMP). A flat surface on the upper face of the interconnecting level 30A is thus obtained.

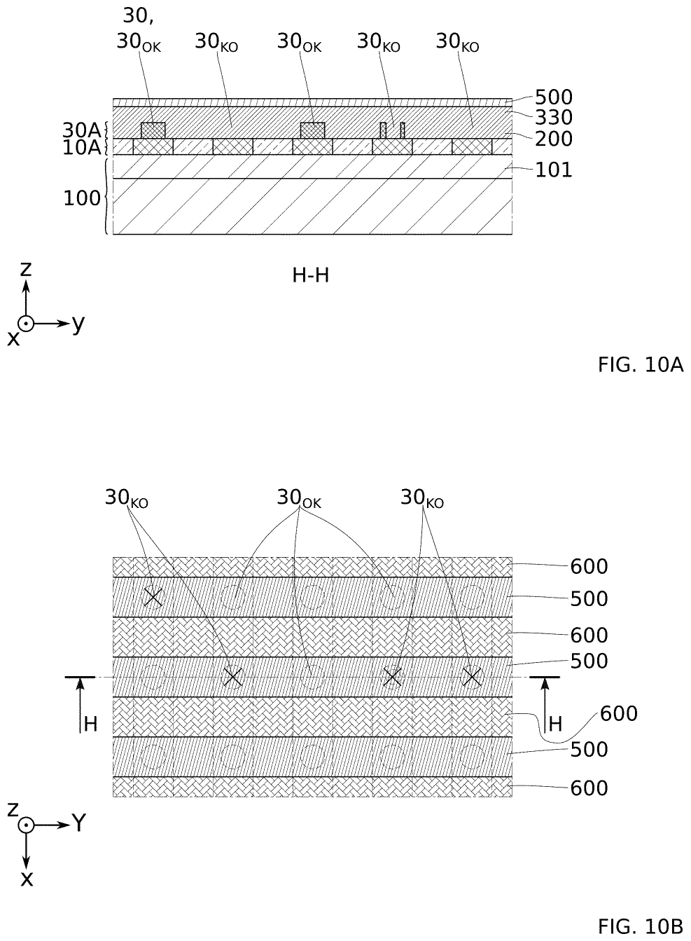

As illustrated in FIGS. 10A, 10B, another stack of a dielectric layer 330 and an etching mask 500 is formed on the upper face of the interconnecting level 30A, towards the formation of the second track level 20A. A resin mask 600 is formed by lithography on this stack so as to define the tracks of the second level.

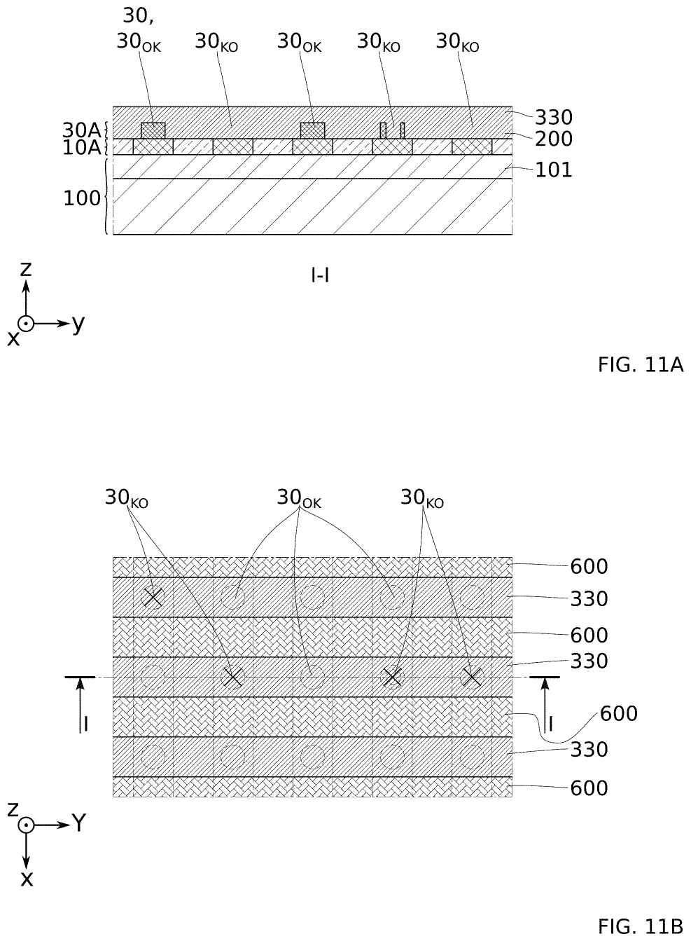

As illustrated in FIGS. 11A, 11B, the etching mask 500 is etched through the resin mask 600. The track patterns of the mask 600 are thus transferred into the etching mask 500. The resin mask 600 can then be removed, for example by stripping.

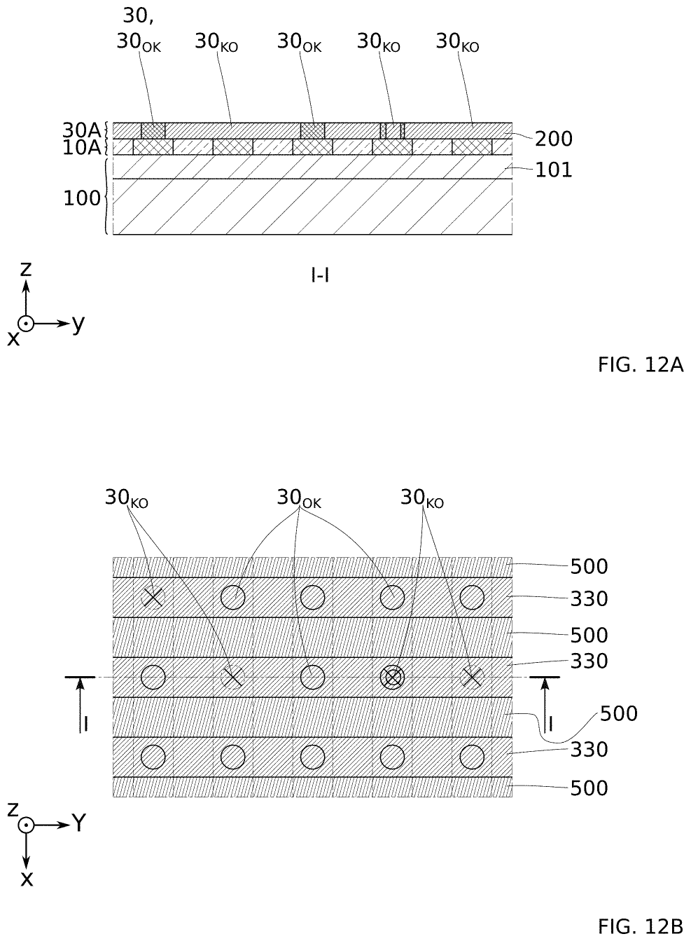

As illustrated in FIGS. 12A, 12B, the dielectric layer 330 is etched through the etching mask 500. This etching can be, in this case, carried out in a more standard manner, typically by dry etching. The track patterns are thus transferred into the dielectric layer 330.

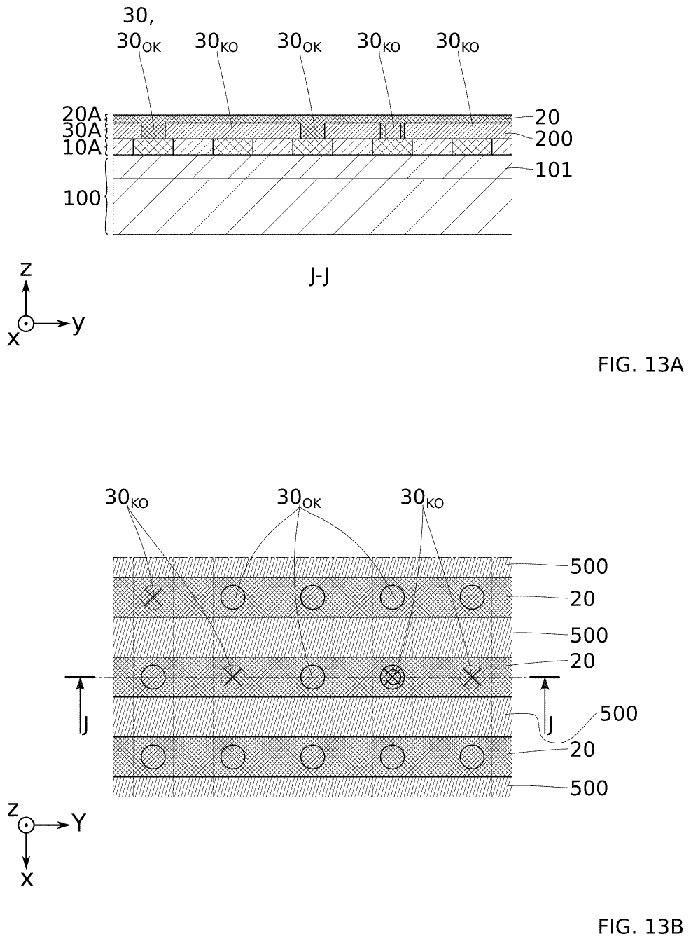

As illustrated in FIGS. 13A, 13B, a copper deposition is carried out as above, so as to fill the track patterns. The tracks 20 of the second track level 20A are thus formed. A planarisation by CMP is then carried out, so as to obtain a flat surface on the upper face of the second track level 20A.

Other track and interconnecting levels can be produced above the levels 10A, 30A, 20A.

A network of vias 30 randomly connected is thus obtained, with totally connected vias 300K and vias 30KO which are not connected, or which are partially connected. The position of the different vias 300K, 30KO and their number varies from one PUF zone to another PUF zone, from one microelectronic chip to another microelectronic chip.

In view of the description above, it clearly appears that the method proposed offers a particularly effective solution to produce a PUF-type individualisation zone. The invention is not limited to the embodiments described above and extends to all the embodiments covered by the claims.

The embodiment described above is integrated in the production of semi-conductor compounds at the so-called “copper” back end level. The invention however extends to embodiments using a conductive material other than copper. For this, a person skilled in the art will easily know how to carry out the adaptations necessary in terms of choosing materials and steps to proceed with.

1. A method for producing an individualisation zone of a microelectronic chip, said chip comprising at least:
one first and one second levels of electric tracks,
one interconnecting level located between the first and second levels of electric tracks and comprising vias intended to electrically connect the electric tracks of the first level with the electric tracks of the second level,
the chip having at least one other zone, distinct from the individualisation zone, intended to form a functional zone of the chip,
the method comprising at least the following steps carried out at the level of the individualisation zone of the chip:
providing at least the first level of electric tracks,
forming at least one dielectric layer on the first level, said dielectric layer being with the basis of a dielectric material comprising a non-zero nitrogen concentration,
forming on the at least one dielectric layer, an etching mask having mask openings located at least partially to the right of the electric tracks and making the at least one dielectric layer accessible,
etching the at least one dielectric layer through mask openings by at least one vapour phase hydrofluoric acid-based etching, so as to form:
openings leading to the first level of the electric tracks,
nitrogenous residues randomly distributed at the level of certain openings, the openings thus comprising openings with nitrogenous residues and openings without residues,
filling the openings with an electrically conductive material so as to form at least the vias of the interconnecting level, said vias comprising functional vias at the level of the openings without residues and inactive vias at the level of the openings with nitrogenous residues,
said method further comprising, prior to the formation of nitrogenous residues in the individualisation zone, a formation of a protective mask on the zone intended to form the functional zone of the chip.

2. The method according to claim 1, wherein the forming of the at least one dielectric layer with the basis of a dielectric material comprising a non-zero nitrogen concentration is carried out by chemical vapour deposition from a gaseous precursor comprising silicon and a nitrogenous compound source.

3. The method according to claim 2, wherein the gaseous precursor is taken from among silane (SiH4), tetraethoxysilane (TEOS), tetramethoxysilane (TMOS), and wherein the nitrogenous compound source is an N2O or N2 gas.

4. The method according to claim 1, wherein the at least one dielectric layer is SiOxNy- or SixNy- or SiOxCyNz-based with x, y, z of the non-zero positive rational numbers.

5. The method according to claim 1, further comprising, after formation of the at least one dielectric layer, a thermal annealing carried out under nitrogen flow.

6. The method according to claim 1, wherein the nitrogen atomic concentration of the dielectric material of the at least one dielectric layer is greater than 1% at.

7. The method according to claim 1, wherein the etching mask is formed with the basis of a material A, such that the etching has an etching selectivity S dielec: A between the dielectric material and the material A greater than or equal to 10:1.

8. The method according to claim 7, wherein the material A is chosen from among TiN, SiN, Si.

9. The method according to claim 1, wherein the formation forming of the at least one dielectric layer is configured such that the nitrogen concentration is inhomogeneous with the at least one dielectric layer.

10. The method according to claim 9, combined with claim 2, wherein the chip is inclined vis-à-vis the nitrogenous compound source during the formation of the at least one dielectric layer.

11. A method for producing a microelectronic device comprising at least one integrated circuit, the integrated circuit comprising at least:
one first and one second levels of electric tracks,
one interconnecting level located between the first and second levels of electric tracks and comprising vias intended to electrically connect the tracks of the first level with the tracks of the second level,
one individualisation zone produced by implementing the method according to claim 1, on only one part of the integrated circuit.
